(19) United States
(12) Patent Application Publication
(10) Pub. No.: US 2016/0111194 A1
(43) Pub. Date: Apr. 21, 2016

(54) CHIP ELECTRONIC COMPONENT AND BOARD HAVING THE SAME

(71) Applicant: SAMSUNG ELECTRO-MECHANICS CO., LTD., Suwon-Si (KR)

(72) Inventor: Dong Jin JEONG, Suwon-Si (KR)

(21) Appl. No.: 14/677,826

(22) Filed: Apr. 2, 2015

(30) Foreign Application Priority Data
Oct. 16, 2014 (KR) 10-2014-0139623

(51) Int. Cl. H01F 27/28; H01F 27/24

(52) U.S. Cl. CPC H01F 27/2804; H01F 27/24; H01F 2027/2809

(57) ABSTRACT

There is provided a chip electronic component including: an insulating substrate; a first internal coil part which is disposed on one surface of the insulating substrate; a second internal coil part which is disposed on the other surface of the insulating substrate opposing one surface of the insulating substrate; a via penetrating through the insulating substrate and connecting the first and second internal coil parts to each other; and first and second via pads disposed on one surface and the other surface of the insulating substrate, respectively, so as to cover the via, wherein when a width of each of a coil pattern of the first and second coil parts is a and a maximum width of each of the first and second via pads is b, 1≦b/a<2.3 is satisfied.

### CROSS-REFERENCE TO RELATED APPLICATION

This application claims the priority and benefit of Korean Patent Application No. 10-2014-0139623 filed on Oct. 16, 2014, with the Korean Intellectual Property Office, the disclosure of which is incorporated herein by reference.

### BACKGROUND

The present disclosure relates to a chip electronic component and a board having the same.

An inductor, a chip electronic component, is a representative passive element configuring an electronic circuit, together with a resistor and a capacitor, in order to remove noise therefrom.

A thin film type inductor may be manufactured by forming an internal coil part through a plating process, forming a magnetic body by hardening a magnetic powder-resin composite in which magnetic powder and resin are mixed, and forming external electrodes on outer surfaces of the magnetic body.

### RELATED ART DOCUMENT

(Patent Document 1) Japanese Patent Laid-Open Publication No. 2007-067214

### SUMMARY

An aspect of the present disclosure may provide a chip electronic component in which excessive growth of via pads is suppressed to prevent short-circuits due to the excessive growth of the via pads and prevent loss of inductance due to an enlarged area of the via pads.

According to an aspect of the present disclosure, a chip electronic component may include: an insulating substrate; a first internal coil part which is disposed on one surface of the insulating substrate; a second internal coil part which is disposed on the other surface of the insulating substrate opposing one surface of the insulating substrate; a via penetrating through the insulating substrate and connecting the first and second internal coil parts to each other; and first and second via pads disposed on one surface and the other surface of the insulating substrate, respectively, so as to cover the via, wherein when a width of each of a coil pattern of the first and second coil parts is a and a maximum width of each of the first and second via pads is b, 1≦b/a<2.3 is satisfied.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic perspective view of a chip electronic component according to an exemplary embodiment in the present disclosure, together with an internal coil part included therein;

FIG. 2 is a cross-sectional view taken along line I-I′ of FIG. 1;

FIG. 3 is schematic plan view of via pads according to an exemplary embodiment in the present disclosure;

FIG. 4 is a cross-sectional view taken along line II-II′ of FIG. 1;

FIG. 5 is a perspective view of a board in which the chip electronic component of FIG. 1 is mounted on a printed circuit board; and

FIG. 6 is a perspective view of a board in which a chip electronic component is mounted on a printed circuit board, according to another exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

### Chip Electronic Component

Hereinafter, a chip electronic component according to an exemplary embodiment of the present disclosure will be described, and in particular, a thin film type inductor will be described. However, the present inventive concept is not limited thereto.

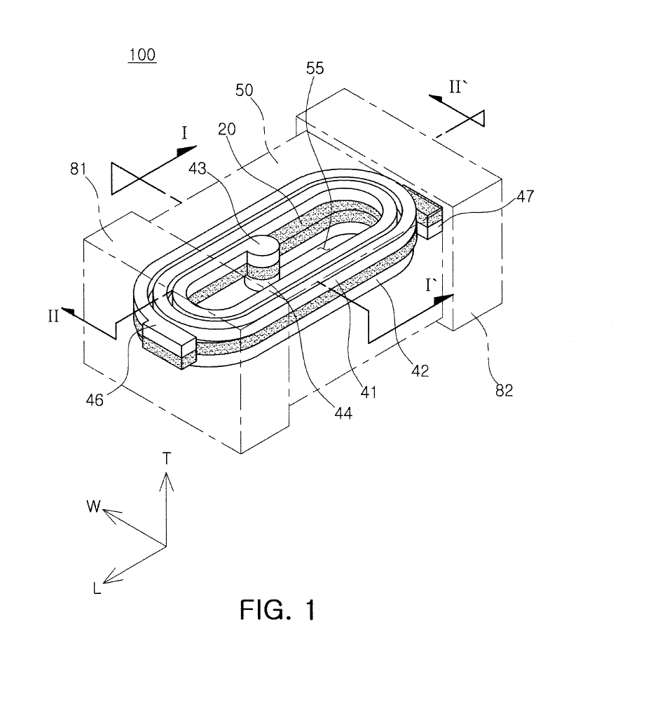

FIG. 1 is a schematic perspective view of a chip electronic component according to an exemplary embodiment in the present disclosure, together with an internal coil part included therein.

Referring to FIG. 1, a thin film type inductor used in a power line of a power supplying circuit is illustrated as an example of a chip electronic component.

A chip electronic component 100 according to an exemplary embodiment may include a magnetic body 50, internal coil parts 41 and 42 buried in the magnetic body 50, and first and second external electrodes 81 and 82 disposed on outer surfaces of the magnetic body 50 and electrically connected to the internal coil parts 41 and 42.

In the chip electronic component 100 according to an exemplary embodiment, a ‘length’ direction refers to an ‘L’ direction of FIG. 1, a ‘width’ direction refers to a ‘W’ direction of FIG. 1, and a ‘thickness’ direction refers to a ‘T’ direction of FIG. 1.

The magnetic body 50 may form the exterior appearance of the chip electronic inductor 100 and may be formed of any material that exhibits magnetic properties. For example, the magnetic body 50 may be filled with ferrite or magnetic metal powder.

Examples of the ferrite may include Mn-Zn based ferrite, Ni—Zn based ferrite, Ni—Zn—Cu based ferrite, Mn—Mg based ferrite, Ba based ferrite, and Li based ferrite.

The magnetic metal powder may contain at least one selected from the group consisting of Fe, Si, Cr, Al, and Ni. For example, the magnetic metal powder may include a Fe—Si—B—Cr based amorphous metal, but is not limited thereto.

The magnetic metal powder may have a particle diameter of 0.1 μm to 30 μm and may be dispersed in a thermosetting resin such as an epoxy resin or a polyimide resin.

The first internal coil part 41 having a coil pattern may be formed on one surface of an insulating substrate 20 disposed inside the magnetic body 50, and the second internal coil part 42 having a coil pattern may be formed on the other surface of the insulating surface 20 opposing one surface of the insulating substrate 20.

The first and second internal coil parts 41 and 42 may have a spiral shape and be formed by using an electroplating method.

The insulating substrate 20 may be, for example, a polypropylene glycol (PPG) substrate, a ferrite substrate, or a metal based soft magnetic substrate.

The insulating substrate 20 may have a through-hole formed in a central portion thereof, wherein the through-hole may be filled with a magnetic material to form a core part 55. The core part 55 may be formed to be filled with the magnetic material, thereby improving inductance Ls.

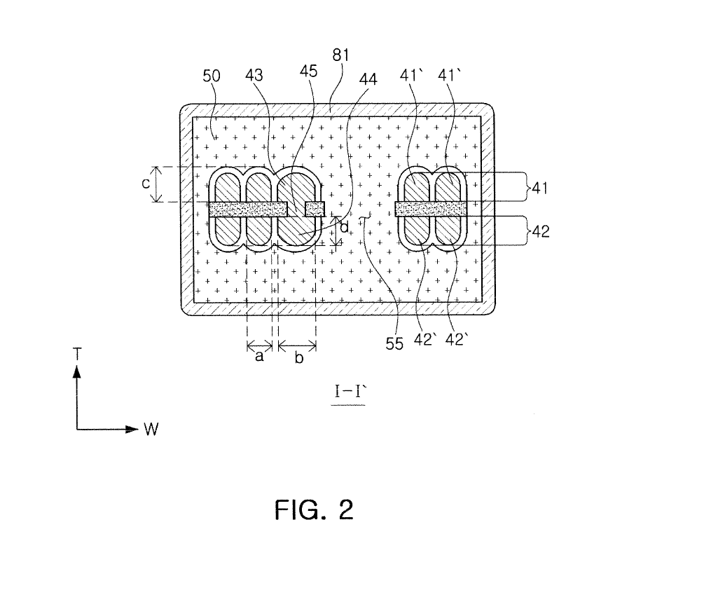

FIG. 2 is a cross-sectional view taken along line I-I′ of FIG. 1.

Referring to FIG. 2, the first and second internal coil parts 41 and 42 formed on one surface and the other surface of the insulating substrate 20, respectively, may be connected to each other through a via 45 penetrating through the insulating substrate 20.

First and second via pads 43 and 44 may be formed on one surface and the other surface of the insulating substrate 20, respectively, so as to cover the via 45.

The first via pad 43 may be formed by extending one end portion of the first internal coil part 41, and the second via pad 44 may be formed by extending one end portion of the second internal coil part 42.

The first and second via pads 43 and 44 may be formed by using an electroplating method, similar to the first and second internal coil parts 41 and 42.

Here, an excessive amount of plating solution may be present in regions of the internal coil parts in which the via pads are to be formed than in other regions of the internal coil parts in a plating process of forming the via pads, causing excessive growth of the via pads, and thus, short-circuits between the via pads and portions of the internal coil parts adjacent to the via pads may occur. In addition, as an area of the via pad is increased due to the excessive growth of the via pad, an area of the core part may be decreased and a magnetic material filling the core part may be decreased, whereby inductance (Ls) characteristics may deteriorate.

Therefore, in the present exemplary embodiment, the above-mentioned problems have been solved by allowing a width a of each of coil patterns 41′ and 42′ of the first and second internal coil parts 41 and 42 and a maximum width b of each of the first and second via pads 43 and 44 to satisfy 1≦b/a_{<}2.3.

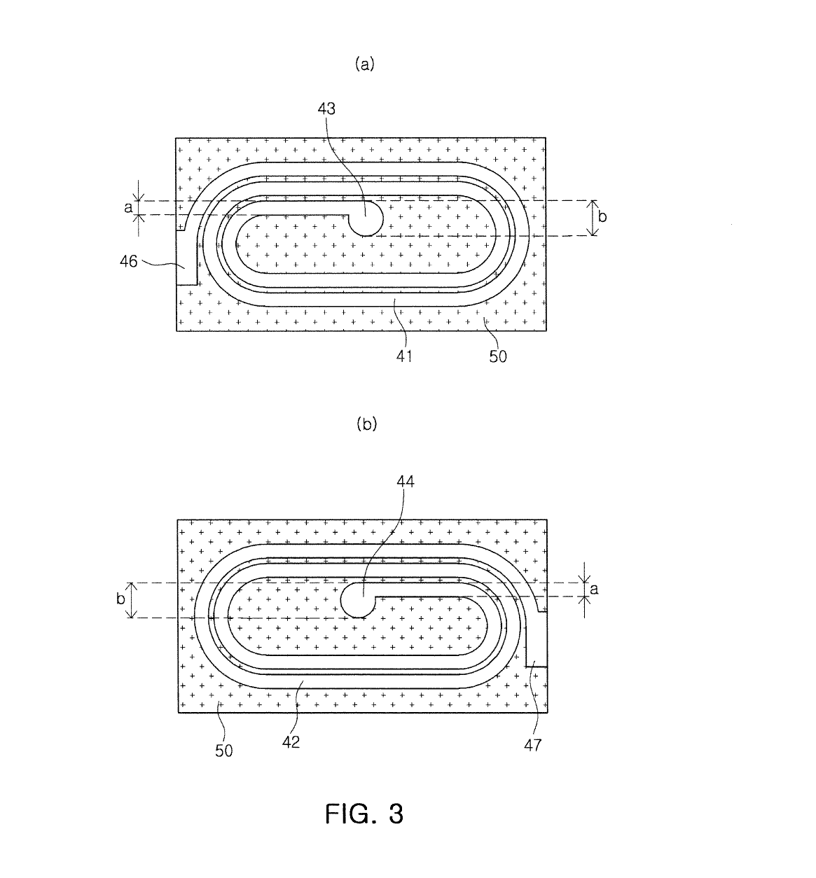

FIGS. 3A and 3B are schematic plan views of via pads according to an exemplary embodiment in the present disclosure.

Referring to FIG. 3, the maximum width b of each of the first and second via pads 43 and 44 refers to the largest width thereof measured in the same direction as a direction in which the width a of each end portion of the coil patterns 41′ and 42′ of the first and second internal coil parts 41 and 42 connected to the first and second via pads 43 and 44 is measured.

When 1≦b/a<2.3 is satisfied, a difference between a thickness c of each of the internal coil parts 41 and 42 and a thickness d of each of the via pads 43 and 44 may be reduced, and short-circuits due to the excessive growth of the via pads may be prevented.

In addition, an open defect that the via 45 and the via pads 43 and 44 are misaligned with each other to thereby be electrically disconnected from each other may be prevented, and the area of the core part 55 filled with the magnetic material may be maximized, whereby high inductance (Ls) may be obtained.

In a case in which b/a is less than 1, the open defect, in which the via 45 and the via pads 43 and 44 are misaligned with each other to thereby be electrically disconnected from each other, may occur. In a case in which b/a is 2.3 or more, as the width of the via pad becomes excessively increased, the via pad becomes excessively thicker than the internal coil part, whereby short-circuits may occur due to the excessive growth of the via pad.

Referring to FIG. 2, when the thickness of each of the coil patterns 41′ and 42′ in the first and second internal coil parts 41 and 42 is c and the thickness of each of the first and second via pads 43 and 44 is d, d/c may be 1 or less.

In a case in which d/c exceeds 1, the via pad may become excessively thicker than the internal coil part, and thus, short-circuits may occur between the via pad and the coil pattern adjacent thereto.

The width a of each of the coil patterns 41′ and 42′ of the first and second internal coil parts 41 and 42 according to an exemplary embodiment may range from 30 μm to 200 μm.

The maximum width b of each of the first and second via pads 43 and 44 according to an exemplary embodiment may range from 60 μm to 250 μm.

However, the width a of each of the coil patterns 41′ and 42′ of the first and second internal coil parts 41 and 42 and the maximum width b of each of the first and second via pads 43 and 44 are not limited thereto, and may be adjusted to satisfy

The first and second internal coil parts 41 and 42, the via 45, and the first and second via pads 43 and 44 may be formed of a metal having excellent electrical conductivity, such as silver (Ag), palladium (Pd), aluminum (Al), nickel (Ni), titanium (Ti), gold (Au), copper (Cu), platinum (Pt), or an alloy thereof.

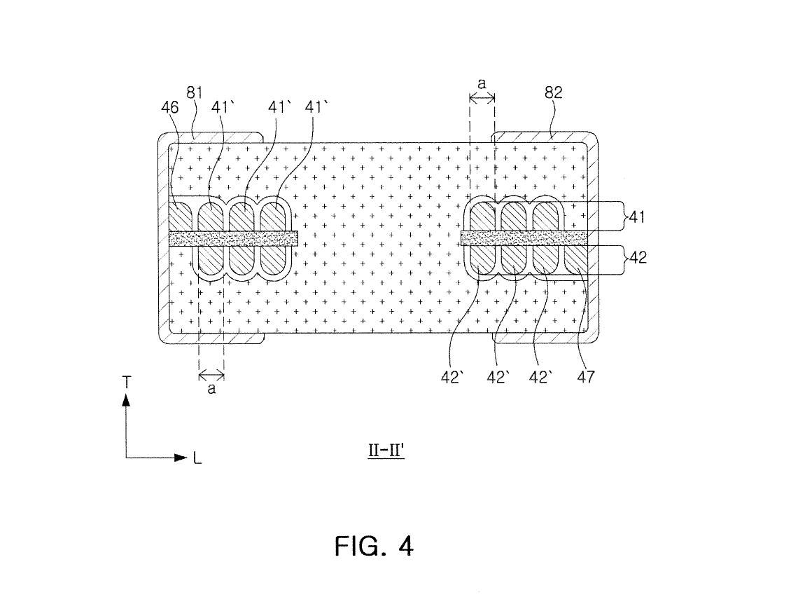

FIG. 4 is a cross-sectional view taken along line II-II′ of FIG. 1.

Referring to FIG. 4, the other end portion of the first internal coil part 41 may be extended to form a first lead portion 46 exposed to one end surface of the magnetic body 50 in the length (L) direction thereof, and the other end portion of the second internal coil part 42 may be extended to form a second lead portion 47 exposed to the other end surface of the magnetic body 50 in the length (L) direction thereof.

However, the present inventive concept is not limited thereto. For example, the first and second lead portions 46 and 47 may be exposed to at least one surface of the magnetic body 50.

The first and second external electrodes 81 and 82 may be disposed on both end surfaces of the magnetic body 50 in the length (L) direction, respectively, so as to be connected to the first and second lead portions 46 and 47 exposed to both end surfaces of the magnetic body 50 in the length (L) direction, respectively.

The first and second external electrodes 81 and 82 may be formed of a metal having excellent electrical conductivity, such as nickel (Ni), copper (Cu), tin (Sn), silver (Ag), or an alloy thereof.

The following table 1 shows results of a ratio (b/a) of the maximum width b of each of the via pads 43 and 44 to the width of each of the coil patterns 41′ and 42′ of the internal coil parts 41 and 42, a ratio (d/c) of the thickness of each of the first and second via pads 43 and 44 to the thickness of each of the coil patterns 41′ and 42′ of the internal coil parts 41 and 42, and the occurrence of short-circuits, depending on changes in the width a of each of the coil patterns 41′ and 42′ of the internal coil parts 41 and 42 and the maximum width b of each of the via pads 43 and 44.

TABLE 1

| | | | Occurrence of | Open Defect |
|---|---|---|---|---|
| | b/a | d/c | Short-Circuit | (%) |
| 1* | 0.3 | 0.5 | — | 80 |
| 2* | 0.5 | 0.6 | — | 65 |
| 3* | 0.7 | 0.8 | — | 10 |
| 4* | 0.9 | 0.95 | — | 5 |
| 5 | 1.0 | 1 | 0 | 0 |
| 6 | 1.3 | 1 | 0 | 0 |
| 7 | 1.6 | 1 | 0 | 0 |
| 8 | 2.0 | 1 | 0 | 0 |
| 9* | 2.3 | 1.02 | 3 | 0 |
| 10* | 2.6 | 1.1 | 10 | 0 |
| 11* | 3.0 | 1.2 | 50 | 0 |
| 12* | 3.5 | 1.37 | 70 | 0 |

(*Comparative Example)

As seen in the above table, when 1≦b/a<2.3 is satisfied, a thickness difference between the internal coil parts 41 and 42 and the via pads 43 and 44 is reduced, and d/c≦1 can be satisfied. In addition, the short-circuits due to the excessive growth of the via pads may be prevented, and the open defect may be prevented.

### Board Having Chip Electronic Component

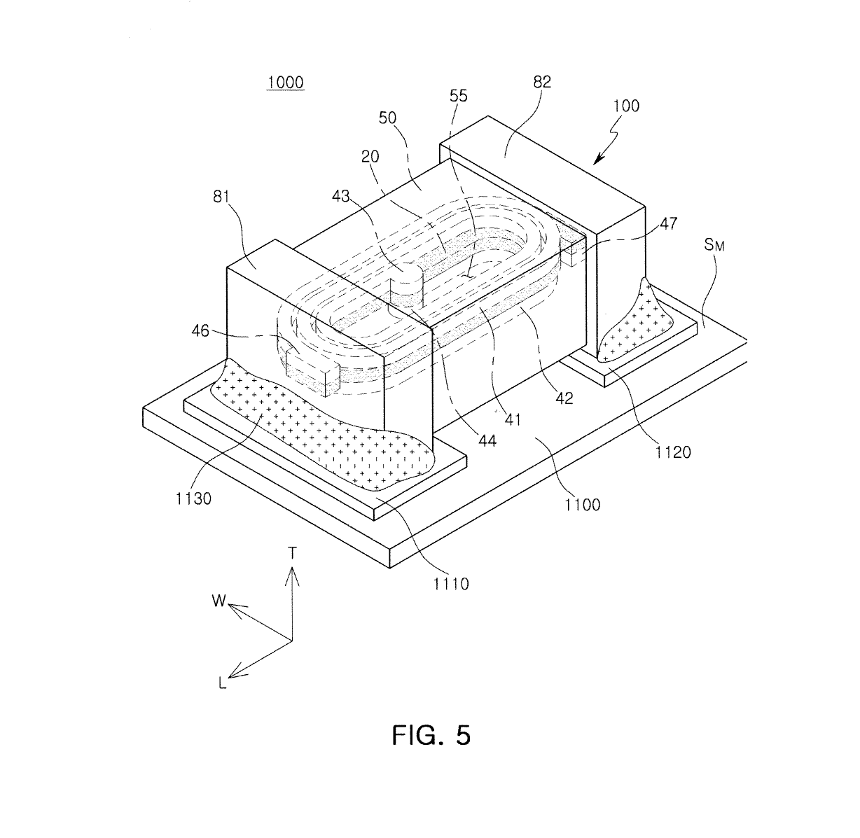

FIG. 5 is a perspective view of a board in which the chip electronic component of FIG. 1 is mounted on a printed circuit board.

Referring to FIG. 5, a board 1000 having a chip electronic component 100 according to an exemplary embodiment in the present disclosure may include: the chip electronic component 100; and a printed circuit board 1100 on which the chip electronic component 100 is mounted, and first and second electrode pads 1110 and 1120 may be formed to be spaced apart from each other on an upper surface of the printed circuit board 1100.

Here, the chip electronic component 100 may be electrically connected to the printed circuit board 1100 by solders 1130 in a state in which the first and second external electrodes 81 and 82 formed on both end surfaces of the chip electronic component 100 are positioned to contact the first and second electrode pads 1110 and 1120, respectively.

The internal coil parts 41 and 42 of the chip electronic component 100 mounted on the printed circuit board may be disposed to be parallel to amounting surface (S_{M}) of the printed circuit board 1100.

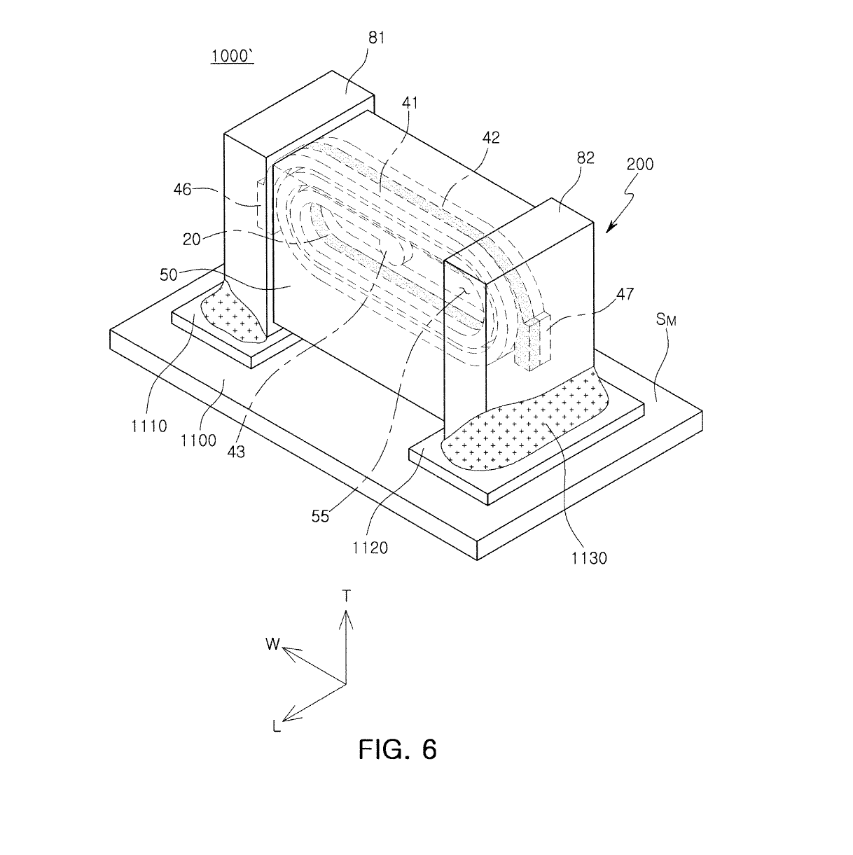

FIG. 6 is a perspective view of a board in which a chip electronic component is mounted on a printed circuit board, according to another exemplary embodiment of the present disclosure.

Referring to FIG. 6, in a board 1000′ having a chip electronic component 200 according to another exemplary embodiment of the present disclosure, internal coil parts 41 and 42 of the chip electronic component 200 may be disposed to be perpendicular to a mounting surface (S_{M}) of the printed circuit board 1100.

A description of features overlapped with those of the chip electronic component according to the previous exemplary embodiment will be omitted.

As set forth above, according to exemplary embodiments, short-circuits due to excessive growth of the via pads may be prevented, and loss of inductance due to an enlarged area of the via pads may be prevented.

While exemplary embodiments have been shown and described above, it will be apparent to those skilled in the art that modifications and variations could be made without departing from the scope of the invention as defined by the appended claims.

What is claimed is:

1. A chip electronic component comprising:
an insulating substrate;
a first internal coil part which is disposed on one surface of the insulating substrate;
a second internal coil part which is disposed on the other surface of the insulating substrate opposing one surface of the insulating substrate;
a via penetrating through the insulating substrate and connecting the first and second internal coil parts to each other; and
first and second via pads disposed on one surface and the other surface of the insulating substrate, respectively, so as to cover the via,
wherein when a width of each of a coil pattern of the first and second coil parts is a and a maximum width of each of the first and second via pads is b, 1≦b/a<2.3 is satisfied.

2. The chip electronic component of claim 1, wherein when a thickness of each of a coil pattern of the first and second coil parts is c and a thickness of each of the first and second via pads is d, d/c is 1 or less.

3. The chip electronic component of claim 1, wherein the first via pad is extended from one end portion of the first internal coil part, and
the second via pad is extended from one end portion of the second internal coil part.

4. The chip electronic component of claim 1, wherein the first and second internal coil parts and the first and second via pads are formed using a plating process.

5. The chip electronic component of claim 1, wherein the width of each of a coil pattern of the first and second coil parts is 30 μm to 200 μm.

6. The chip electronic component of claim 1, wherein the maximum width of each of the first and second via pads is 60 μm to 250 μm.

7. The chip electronic component of claim 1, further comprising a magnetic body enclosing the first and second internal coil parts,
wherein the magnetic body contains a magnetic metal powder.

8. The chip electronic component of claim 1, wherein the insulating substrate has a through-hole disposed in a central portion thereof, the through-hole being filled with a magnetic material to form a core part.

9. The chip electronic component of claim 7, wherein the other end portions of the first and second internal coil parts are extended to form lead portions exposed to at least one surface of the magnetic body.

10. A chip electronic component comprising:
an insulating substrate;
a first internal coil part which is disposed on one surface of the insulating substrate;
a second internal coil part which is disposed on the other surface of the insulating substrate opposing one surface of the insulating substrate;
a via penetrating through the insulating substrate and connecting the first and second internal coil parts to each other; and
first and second via pads disposed on one surface and the other surface of the insulating substrate, respectively, so as to cover the via,
wherein when a thickness of each of a coil pattern of the first and second coil parts is c and a thickness of each of the first and second via pads is d, d/c is 1 or less.

11. The chip electronic component of claim 10, wherein when a width of each of a coil pattern of the first and second coil parts is a and a maximum width of each of the first and second via pads is b, 1≦b/a<2.3 is satisfied.

12. The chip electronic component of claim 10, wherein the first and second internal coil parts and the first and second via pads are formed using a plating process.

13. The chip electronic component of claim 10, wherein the width of each of a coil pattern of the first and second coil parts is 30 μm to 200 μm.

14. The chip electronic component of claim 10, wherein the maximum width of each of the first and second via pads is 60 μm to 250 μm.

15. A board having a chip electronic component, the board comprising:
a printed circuit board on which first and second electrode pads are disposed; and
the chip electronic component of claim 1 mounted on the printed circuit board.

16. The board of claim 15, wherein the first and second internal coil parts are disposed to be parallel to a mounting surface of the printed circuit board.

17. The board of claim 15, wherein the first and second internal coil parts are disposed to be perpendicular to a mounting surface of the printed circuit board.
